(19) United States
(12) Patent Application Publication
(10) Pub. No.: US 2007/0028278 A1
(43) Pub. Date: Feb. 1, 2007

(54) System and method for providing pre-encoded audio content to a television in a communications network

(76) Inventors: Robert B. Sigmon JR., Fremont, CA (US); Lena Pavlovskaia, Cupertino, CA (US); Airan Landau, San Jose, CA (US)

Correspondence Address: BROMBERG & SUNSTEIN LLP, 125 SUMMER STREET, BOSTON, MA, 02110-1618, US

(21) Appl. No.: 11/258,602

(22) Filed: Oct. 25, 2005

Related U.S. Application Data
(60) Provisional application No. 60/702,820, filed on Jul. 27, 2005.

(51) Int. Cl. H04N 7/16; G06F 17/00; H04N 7/173; H04H 9/00; G06F 15/00

(52) U.S. Cl. 725/113; 725/18; 725/112; 725/135; 715/500.1

(57) ABSTRACT

A system and method for providing encoded audio content associated with visual source material in a communication network to a communication device associated with a television is disclosed. An interactive session is first established between the communication device and a content distribution platform in the communication network. A processor at the content distribution platform is assigned to the interactive session. The user may then request interactive content wherein the communication device sends a request for content to the content distribution platform and the content distribution platform retrieves the content. The visual source material may be a web page or other visual content. In order to display the web page on the television, the web page is encoded in a format that a decoder associated with the television can decode. For example, the web page may be encoded as an MPEG video stream wherein the decoder can decode an MPEG stream. The content distribution platform, which can be a cable headend, then receives a request for encoded audio content associated with a link in the visual source material wherein the request originates through use of the communication device associated with the television. The content distribution platform retrieves the encoded audio content and determines that the encoded audio content is in a format that can be decoded by the decoder. The content distribution platform then multiplexes the encoded audio content and at least a portion of the visual source material to form a multiplexed stream. The multiplexed stream is in an encoded format that can be decoded by the communication device associated with the television.

### PRIORITY

The present U.S. patent application claims priority from U.S. provisional patent application Ser. No. 60/702,820 that was filed on Jul. 27, 2005 entitled “System and Method for Providing Pre-encoded Audio Content to a Television in a Communications Network,” which is incorporated herein by reference in its entirety.

### TECHNICAL FIELD AND BACKGROUND ART

The present invention relates to the playing of audio content and more specifically to playing audio content at a television in a communication network.

It is known in the prior art to display video and accompanying audio content on a computer that is attached to the Internet 6 as shown in FIG. 1. A user of a client computer 4 having an associated web browser 3 can request the display of a web page 2 from a server computer 7 by providing the URL (universal resource locator) for the web page 2. When the client computer 4 receives the web page 2, the web page 2 is displayed in a web browser 3. The web page may have an accompanying sound file. The displayed web page 2 is simply a document that contains content in a format, such as HTML, along with links to other content, such as other web pages, files, video content, audio content and combined video and audio content. The user of the client computer 4 can request audio or vide/audio content 8 by selecting a link that requests the transmission of the content 8 from the server computer 7. The content 8 may be in any one of a number of different formats. For example, the content may be in Apple® Computer's Quicktime format, MPEG-2 format, MPEG-1 Layer 3, A1FF, or Microsoft's® Window's Media format. After the user has requested the content, the content is transmitted to the client's computer 4 from the address associated with the link. Given that the content is in a particular format and is generally compressed, the video/audio or audio must be decoded by the client computer 4. The audio or video/audio content is decoded by a program separate from the web browser which may be a plug-in 5 to the web browser. The content is received and the web browser directs the content to the plug-in. The plug-in is run and decodes the content and displays any video content within the client's web browser while providing any audio to speakers associated with the computer.

In communication networks, wherein the requesting device does not have the capability to decode video/audio content separately from the web page content, and therefore the web page content and the video/audio content are encoded together, the previously described client server system will not work. An example of such a communication network is an interactive cable television system that supports web browsing on televisions wherein the web content is processed at a remote location, such as a cable head end, as shown in FIG. 2. Such a cable television system allows a subscriber to make a request for content using a communication device, such as a set top box 20. The request is sent to the cable headend 22 from a subscriber's set top box 20 and the headend 22 accesses the web page 28 from a server 27. The headend 22 encodes the web page and any accompanying sound 28 in a format that the set top box 20 can decode, and then transmits the web page to the set top box 20. If the web page contains a link to audio content and the subscriber requests the audio content, the audio content must be encoded in the format that the set top box can decode, such as an MPEG format. As such, the head end retrieves the audio content 29 associated with the requested link. The head end 20 decodes the audio content 29 with a decoder 24 regardless of the format using an applicable program and then the encoder re-encodes the audio content along with the web page 28 into the format that the set top box 20 can decode. Such a process is time consuming and processor intensive. Additionally, because the head end decodes and re-encodes the audio content, information is lost, and therefore the audio has less resolution than the originally encoded content.

### SUMMARY OF THE INVENTION

One embodiment of the invention discloses a method of providing encoded audio content associated with visual source material in a communication network to a decoder associated with a television. An interactive session is first established between a content distribution platform and a communication device through the communication network. A processor at the content distribution platform is assigned to the interactive session. The user may then request interactive content wherein the communication device sends a request for content to the content distribution platform and the content distribution platform retrieves the content.

The visual source material may be a web page or other visual content. In order to display the web page on the television, the web page is encoded in a format that the communication device can decode. For example, the web page may be encoded as an MPEG video stream wherein the communication device can decode an MPEG stream.

In one embodiment of the method, a request is received at the content distribution platform for encoded audio content associated with the visual source material. The request originates through use of a communication device associated with the television. The content distribution platform retrieves the encoded audio content and determines the format that the encoded audio content is in. If the encoded audio content is in a format that is decodable by the decoder, the content distribution platform multiplexes the encoded audio content and at least a portion of the visual source material to form an encoded multiplexed stream. Thus, in one embodiment a user at a television may view an MPEG video stream on a television which displays a web page and plays selected audio content. In other embodiments, the processor encodes at least a portion of the web page as MPEG video prior to multiplexing the video with encoded audio.

In certain embodiments, the communication network may be a cable television network or television over IP network.

In yet another embodiment, a selected web page includes a sound or sound file. The content distribution platform receives this sound file, decodes the sound file, and re-encodes the sound file in real-time in a format that the communication device can decode. The encoded sound is then multiplexed with the encoded web page. When the content distribution platform receives a request for playback of audio content that is associated with a link on a displayed web page, the content distribution platform will cause the sound that is originally associated with the web page to stop being streamed and encoded. The content distribution will retrieve the selected pre-encoded audio content and will cause the pre-encoded audio content to be multiplexed and transmitted to the communication device that requested the pre-encoded audio content. The content distribution platform will check to see if an end stream command is received. A user can generate an end stream command by sending a signal from the communication device signaling that the user wants to terminate playback of the encoded audio file. Additionally, an end stream command will be present at the end of the encoded audio file. When the end stream command is received, the content distribution platform will cause the audio decoder to resume decoding and re-encoding the sound file that is associated with the web page.

The invention may also include a system which has one or more modules. The modules may be hardware, software, or a combination of hardware and software. The system is part of the content distribution platform that is in the communication network and is in interactive communication with the communication device associated with the television. The system provides encoded audio content to a decoder associated with the television. The system also produces audio of a better quality, since audio that is already encoded in a format that can be decoded by the decoder is not encoded twice. The system includes a receiver for receiving a request for transmission of the encoded audio content associated with the link in the visual source material and providing the request to a retriever. The retriever retrieves the encoded audio content associated with the link. A switcher contains switching logic that determines if the encoded audio content is in format that is decodable by the decoder. The system also includes an encoder that encodes at least a portion of the video source material into a format that the decoder can decode. If the encoded audio content is in a format that can not be decoded by the decoder, the switcher sends the encoded audio content to a renderer that decodes the audio content. The decoded audio content is then passed to an audio encoder that re-encodes the audio content into a format that can be decoded by the decoder. The system further includes a stream logic module that creates a multiplexed data stream based upon the video source material and the encoded audio content that can be decoded by the communication device. A transmitter within the system transmits via a communication network the multiplexed data stream to the decoder.

### BRIEF DESCRIPTION OF THE DRAWINGS

The foregoing features of the invention will be more readily understood by reference to the following detailed description, taken with reference to the accompanying drawings, in which:

FIG. 1 is a first prior art environment for displaying video content from the internet;

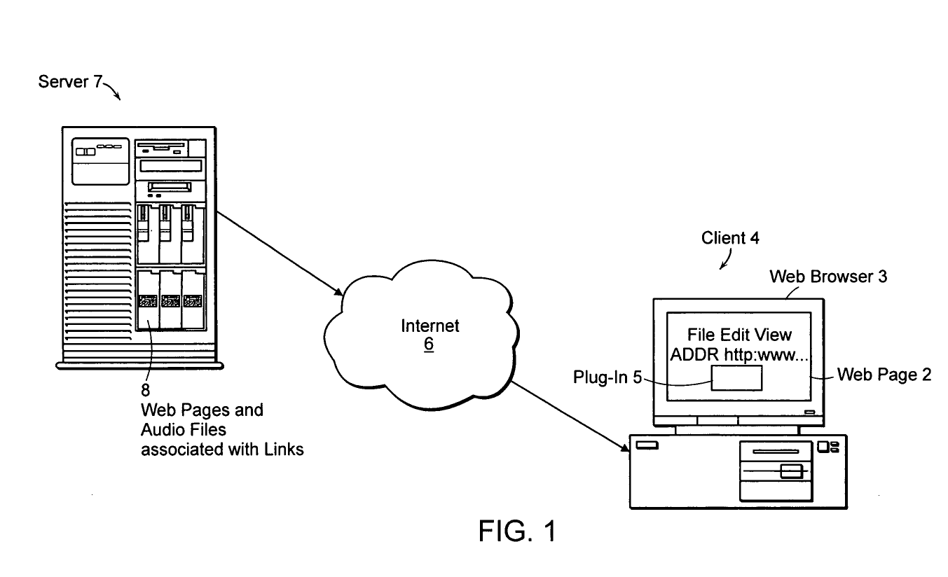

FIG. 2 is a second prior art environment for displaying video content from the internet;

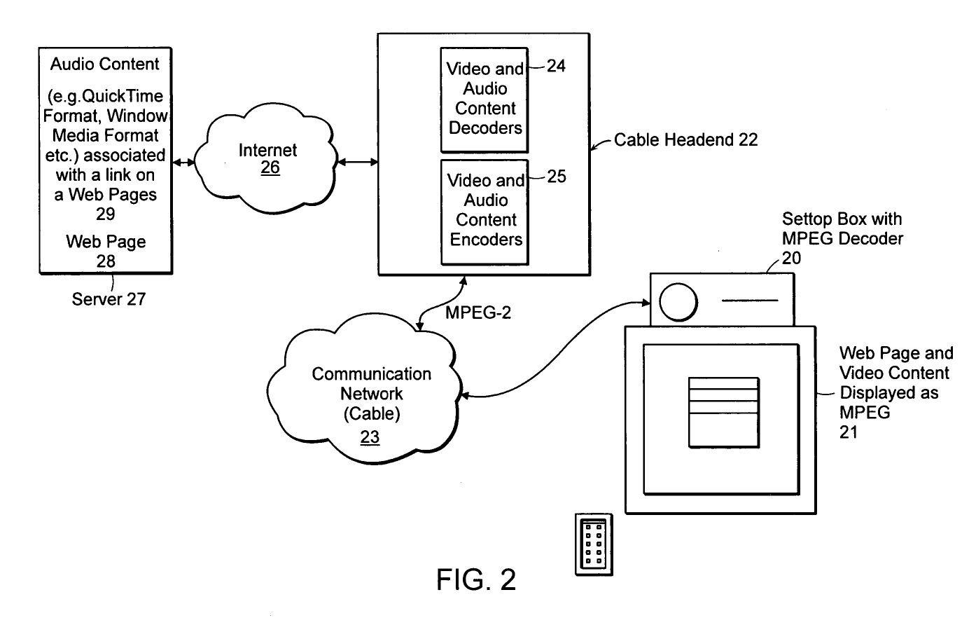

FIG. 3 is an environment showing a first embodiment of the invention;

FIG. 4 is a chart showing the flow of an audio file when a web page or other graphical source is requested by a communication device in the communication network; and

FIG. 5 is a flow chart of an embodiment of the invention for accelerated delivery of audio content to a communication device in a communication network.

### DETAILED DESCRIPTION OF SPECIFIC EMBODIMENTS

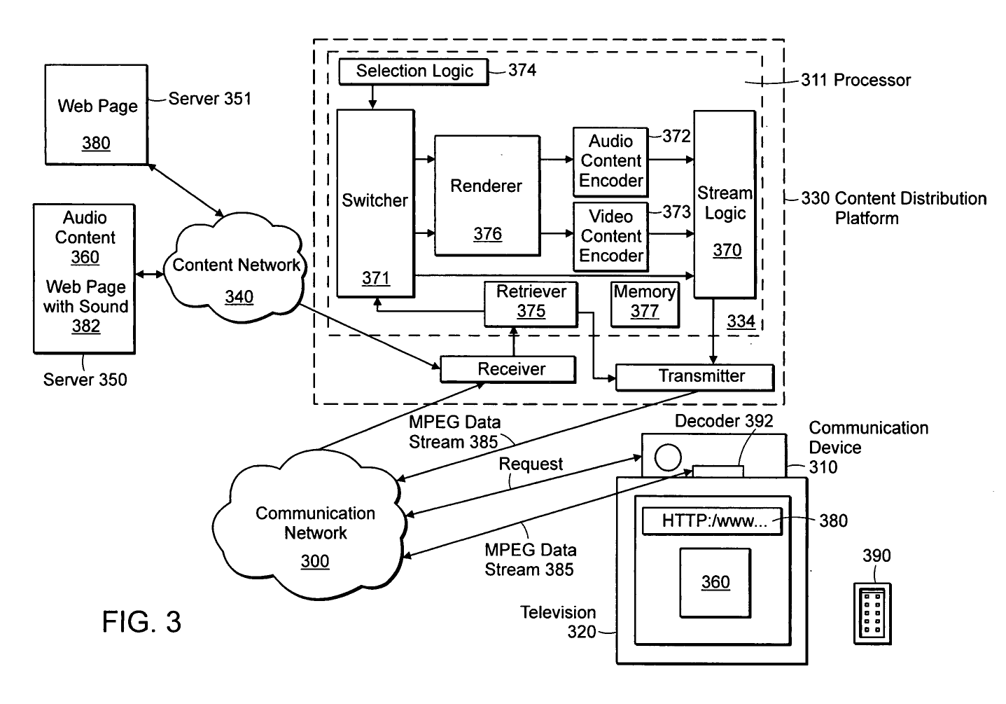

FIG. 3 shows an environment for implementing an embodiment of the invention. The environment is designed to allow a television to receive and display video content associated with a web page. Video content may include audio. In such a system, the television is associated with a communication device. A communication device includes a decoder for receiving and decoding encoded files. Examples of communication devices include a television set-top box, cable card, and a cell phone providing interactive television services. For example, a set-top box may include an MPEG decoder for receiving digitally encoded data and decoding the data. The decoder in such a system does not render video content. Since the communication device does not need to render video content, the communication device does not need a general processor. Such a communication device with limited capabilities minimizes the cost per subscriber for a service provider. In such an environment, all general purpose processing is performed at a content distribution platform, which may be at a central location, such as, a head end in a cable television network or a cable IP network. Examples of other content distribution platforms are: a central switching office for a telephone system and intermediate processing facilities, such as an ISP (Internet Service Provider).

The content distribution platform includes a plurality of processors. Each processor may be associated with one or more interactive processes. For example, the interactive processes may display a movie-on-demand or provide access to the internet. Thus, a user may request an interactive session from the content distribution platform using an input device by sending a predefined request signal to the content distribution platform using a subscriber input device. U.S. Pat. No. 6,100,883 shows such an environment, wherein a content distribution platform has the foregoing features. This patent is incorporated herein by reference in its entirety.

In the embodiment that is shown in FIG. 3, the communication device 310, such as a set-top box, receives a request for an interactive session for accessing the internet or other source material from a user input device 390, such as a remote control or a wired or wireless keyboard. The request is forwarded to the content distribution platform 330 through a communication network 300. The content distribution platform 330 receives the request at a transceiver input 332 and assigns a processor 311 for the interactive session. FIG. 3 shows only a single processor although multiple processors are generally present within the content distribution platform. The request includes at least data associated with the address of a web page 380 or other source material and an address or indicia of the content distribution platform 330. The web page address may be a Universal Resource Locator (URL). It should be understood that other source material, which is not specifically web content, may be requested and decoded by the decoder associated with the television 310.

As shown, the content distribution platform 311 contains a plurality of modules including: a switcher 371, a renderer 376, selection logic 374, an audio content encoder 372, a video content encoder 373, memory 377 and stream logic 370. All of the functions performed by these modules may be performed by a single processor or may be individual processing modules. The content distribution platform further includes a transceiver 332, 334. The storage/memory 377 may be part of the processor or separate from the processor. It should be understood that FIG. 3 shows the individual modules that are used with a single request for an interactive session and audio content associated with a link on a web page or other source location. As stated above, the content distribution platform generally contains a plurality of processors and each processor may handle multiple interactive sessions. It should be noted that some of the modules may be shared by multiple processors. For example, a content distribution platform may have only a single transceiver 332, 334. Additionally, the modules of the content distribution platform 330 form a logical network wherein the modules may be distributed at different locations.

The content distribution platform 330 receives a request for a web page and forwards that request along with the return address for the content distribution platform 330 through a network, such as the internet 340 to a server 350 associated with the address provided by the requesting communication device. The server 350 receives the request and responds to the request by sending the requested web page 380 to the content distribution platform 330. The web page passes through a switcher 371 that uses selection logic 374 to pass the web page to a video content encoder 373. The video content encoder encodes the webpage as an MPEG video stream and stores the encoded video content (web page) to memory 377 and the encoded video content is transmitted to the decoder associated with the requesting television.

The television includes an associated decoder 392 that may be part of the communication device 310, a separate unit, or part of the television. The decoder decodes the encoded content from the content distribution platform. For the remainder of this specification, we will assume that the content distribution platform will encode the content in an MPEG format and the decoder can decode MPEG encoded steams. This will be done for simplification of explanation and in no way should be seen as limiting as other encoding formats may also be employed.

In certain embodiments, the retriever module 375 searches the web page 380 for any audio links or other associated audio content. If an audio link is found on the web page, the retriever will make a request to a server 350 for the audio content 360. When the audio content 360 is received by the retriever 375, the retriever will forward the audio content to switcher 371. The switcher will use the selection logic 374 to determine the format of the retrieved audio content. If the audio content is in a format that can be decoded by the decoder the audio content is directed to memory 377. If the audio content is not in such a format, the selection logic 374 causes the switcher to direct the audio content to a renderer 376 that decodes the audio content and passes the decoded audio content to the audio content encoder 372. The audio content encoder 372 encodes the audio content into a form that can be decoded by the decoder 392. The encoded audio content is stored to memory 377 until a request for such audio content is received by the content distribution platform 330. By pre-encoding the audio content prior to receiving a request for the audio content, the audio content will be either in process of being encoded or ready to be transmitted when a request is received. Therefore, the audio content does not need to be real-time encoded when a request is received.

In another embodiment, the content distribution platform 330 does not retrieve and pre-encode the audio content. Rather, the audio content 360 is only retrieved upon a request being transmitted from the communication device 310 for the content.

In such an embodiment a web page 380 is requested and retrieved by retriever 375. The retriever passes the web page through the switcher 371 that uses the selection logic 374. The selection logic determines that the web page is graphical/video content and passes the web page to the renderer 376 that renders the web page. The renderer sends the rendered web page to video content encoder 373. The video content encoder 373 encodes the web page 380 into an MPEG video format. The encoded web page is passed to stream logic 370 that converts the encoded web page into a video stream. The video stream is then sent through the transmitter 334 to the decoder 392 and displayed on the television 320. The video content encoder 373 also provides a copy of the encoded web page to memory 377.

A subscriber makes a request for audio content 360 that is associated with a link on the requested web page 380 by using the user input device 390 to select the link. A selection signal is passed through the communication network 300 to the content distribution platform 330 and the content distribution platform 330 identifies the link based upon the selection command and requests the audio content from a server 350. An example of a communication network that allows for selecting a link of a web page that is displayed on a television is described in U.S. patent application Ser. No. 10/895,776 entitled “Television Signal Transmission of Interlinked Data and Navigation Information for use By a Chaser Program” that is assigned to the same assignee and is incorporated herein by reference in its entirety. Further discussion about how such a communication network provides for moving between links that are viewed on a television is disclosed in U.S. patent application Ser. No. 09/997,608 entitled, “System and Method for Hyperlink Navigation Between Frames” that is assigned to the same assignee and is incorporated herein by reference in its entirety.

The requested encoded audio content is received by the receiver 332 and provided to the retriever 375. The retriever forwards the encoded audio content to the switcher 371 and the switcher recognizes that the audio content is in a format that is decodable by the decoder. The switcher 371 then passes the encoded audio content directly to the stream logic 370. The stream logic retrieves the encoded web page from memory 377 and multiplexes the encoded web page and encoded audio content together into an MPEG data stream.

If the requested web page 382 includes a sound file, the selection logic forwards the sound file to the renderer. The renderer 376 decodes the sound file and passes the decoded sound file to the audio content encoder 372 that encodes the sound file. This encoding process is performed in real-time. The re-encoded sound file and the encoded web page are multiplexed into an MPEG stream 385 by the stream logic 370 and transmitted to the decoder using the transmitter 334. When a user selects a link on the web page 382, the audio stream for the sound file is halted and the new requested audio content 360 is inserted into the MPEG stream by the stream logic. The multiplexed information is then transmitted by a transmitter 334 to the decoder 392 associated with television 320. The audio content and the web page are decoded by the decoder 392 and the audio is converted to an analog signal and played through speakers while the video web-page is displayed on the television 320. In general, the video content of the MPEG data stream 385 will be repeatedly transmitted. The video content that is transmitted may be transmitted periodically or when video content changes.

In another embodiment, the content distribution platform will only allow a user to select audio content from web pages that have been pre-identified as having audio content that is in a decodable format by the communication device. The content distribution platform will have a list or database with web page identifiers (addresses) and will include logic that when a request is received for audio content at a link that is not on the list, the content distribution platform 330 will not access the audio and will transmit a message to the communication device 310 that this audio content cannot be accessed. In yet a further embodiment, if the audio content is from a different source, such as a cable television company, all of the audio files that are selectable will be in a compatible format that can be decoded by the decoder 392, and therefore, the processor 311 assigned to the interactive session will not have to encode or decode the audio file. Thus, the switcher will pass the encoded audio content directly to the selection logic bypassing the renderer and the audio content encoder.

Processor cycles are preserved and more interactive sessions may be run on a single processor than in previous television communication networks. Further, the quality of the audio is preserved, since the audio is not decoded and re-encoded.

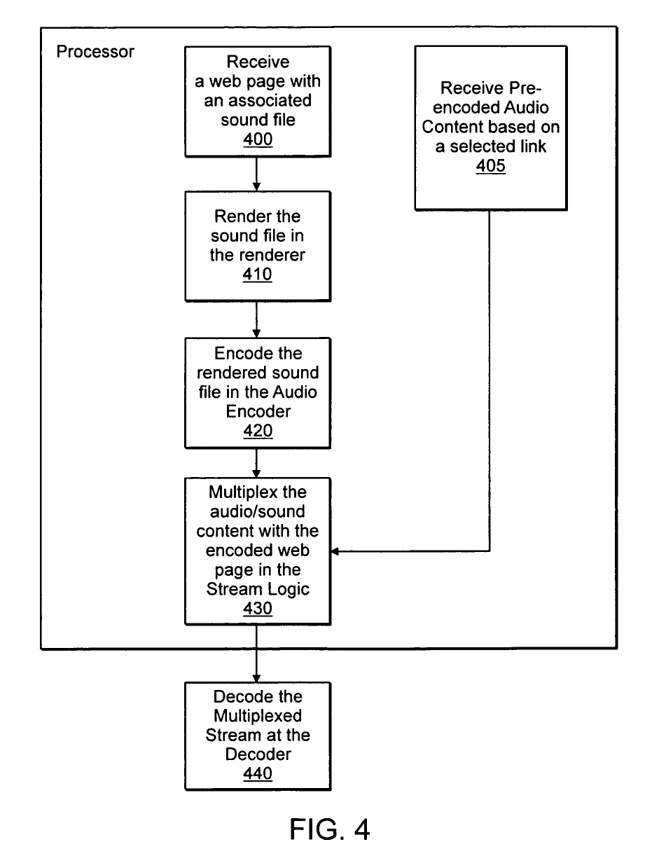

FIG. 4 is a flow chart of the action taken by the information distribution platform when a web page or other graphical source is requested by a communication device in the communication network. In this embodiment of the invention, the audio files associated with a link on the web page or graphical source are not retrieved and re-encoded prior to selection. Rather, the audio files are retrieved upon the receipt of a selection command at the content distribution platform. In the first step, web page/source data is received by the processor (400). An example of a source may be a proprietary display screen that is provided by a cable television provider. If the web page/source has a sound file associated with the web page/source (as distinguished from audio files that are associated with links on the web/page source) the sound file which may be in any one of a number of formats including WAV, AIFF, AAC, Windows Media Audio, MP3 is first decoded by the renderer (410). The content distribution platform then re-encodes the audio file into a format that is compatible with the communication device using the audio encoder (420). The re-encoded sound data is then provided to stream logic that multiplexes the newly encoded sound data with video data (not shown) that is encoded in a format that is capable of being decoded by the communication device (430). For example, if a signal is transmitted from the communication device to a content distribution platform and a web page is requested and retrieved by the content distribution platform, the content distribution platform will encode the web page as MPEG video (MPEG-2, MPEG-4 etc.). The content distribution platform will identify if a sound file or streaming sound data is associated with selected web-page. If the web-page does include sound, the content distribution platform will direct the sound data to the renderer that will decode the audio into a format, such as PCM (pulse code modulation). The decoded audio is then re-encoded into an MPEG or AAC format from the PCM data. The MPEG elementary audio stream is then multiplexed together with the MPEG elementary video stream forming an MPEG stream and the transmitter sends the MPEG stream to the decoder for decoding.

If a user sends a signal to the content distribution platform requesting the selection of an audio file associated with a link on the web-page/source, the controller will cause the retriever to retrieve the audio file (405). If the audio file is encoded in a format that the communication device can decode, the content distribution platform will stop capturing and encoding the sound file associated with the web page. The content distribution platform will then provide the retrieved audio file that is associated with the link to the stream logic and the stream logic will multiplex the encoded audio and encoded web page as an MPEG stream (430). The MPEG stream will then be transmitted to the decoder and decoded for playback and display of the data (440). Thus, when a requested audio file is in a decodable format, the content distribution platform directly multiplexes the audio with any video without having to use processor time for decoding and re-encoding the audio data. Therefore, the assigned processor at the content distribution platform can be used to support more sessions with multiple users since more processing power is available. It should be understood, that the foregoing embodiment of the invention is equally applicable with source content other than web pages. For example, the source may be cable television graphical frame that has associated selectable audio files. In such an embodiment, a request for an audio file may be made to the content distribution platform and the content distribution platform will obtain the audio file from an addressable memory location. The audio file can then be multiplexed with source video and transmitted to the communication device.

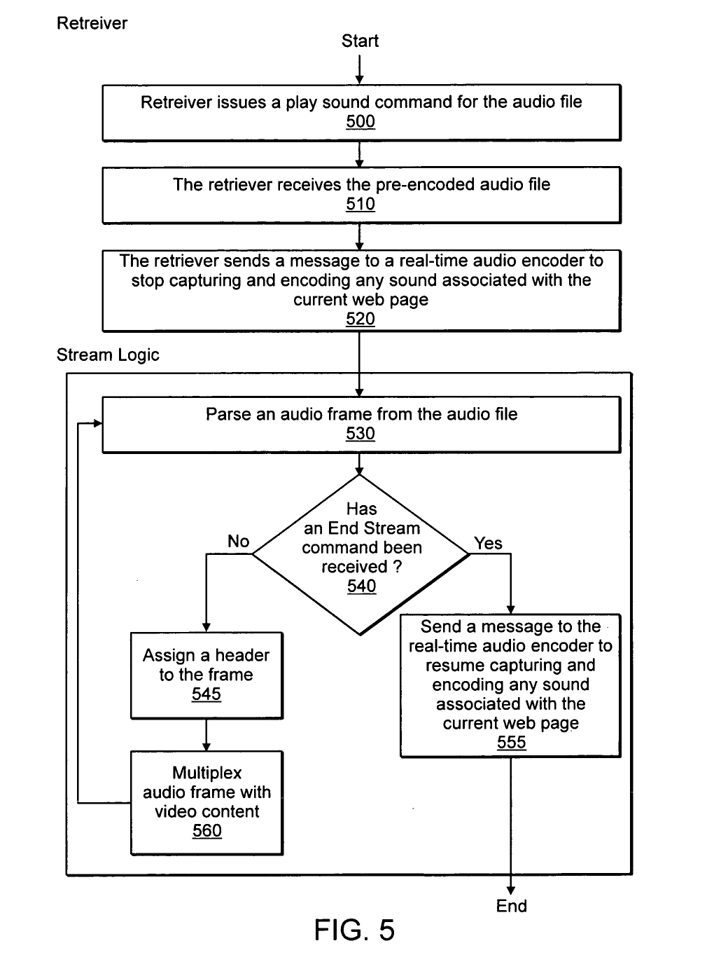

FIG. 5 is a flow chart that elaborates on the process discussed above with respect to FIG. 4 after user selection of a link for audio content. The content distribution platform receives the request for the audio file associated with a link on the web page/source. The retriever module of the processor issues a “play sound” command (500). The retriever module receives the pre-encoded file (510) and then sends a message to the audio encoder to stop capturing and encoding any sound file/stream that is associated with the current web page (520). The audio file is directed by the switching logic through the switcher to the stream logic. The stream logic then begins to parse the audio file (530). A first frame is parsed by searching for a synchronization bit pattern that begins the second frame. The synchronization bit pattern may be an MPEG audio frame header. The stream logic checks to see if an “end stream” command has been received (540). An end stream command may be generated by a user that sends a signal to the content distribution platform indicating that the user would like the audio to stop. An end stream command may also be found at the end of the audio file. If an end stream command is not found, a header is assigned to the frame (545). For example, a PES (packetized elementary stream) header is added to the audio frame. The stream logic then multiplexes the audio frame and the video into an MPEG stream (560). The transceiver transmits the MPEG stream to the communication device through the communication network for decoding (570). The stream logic then continues to parse frames until an end stream command is received. When an end of stream command is received, the stream logic sends a message to the audio encoder indicating that the audio encoder can continue capturing and encoding any sound that is associated with the current web page (555).

It should be understood that the present invention is not limited to communication devices that do not include a general purpose processor. Rather, the preferred embodiment includes a communications device that has limited processing power.

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

What is claimed is:

1. A method for providing encoded audio content associated with visual source material in a communication network to a decoder associated with a television, the method comprising:
receiving a request for encoded audio content associated with the visual source material at a content distribution platform in the communication network wherein the request originates through use of a communication device associated with the television;
retrieving the encoded audio content;
determining whether the encoded audio content is in a format that is decodable by the decoder associated with the request;
if the encoded audio content is in a format that is decodable by the decoder associated with the request, combining the encoded audio content and at least a portion of the visual source material to form a multiplexed stream in an encoded multiplexed format that can be decoded by the decoder.

2. A method according to claim 1, further comprising:
if the audio content is not in a format that is decodable by the decoder associated with the television, switching a switcher to direct the encoded audio content to an audio encoder.

3. A method according to claim 1, further comprising:
switching a switcher so that the encoded audio content is not directed to an audio encoder.

4. A method according to claim 1, wherein the visual source material is a web page.

5. The method according to claim 1, wherein the communication network is a cable television network.

6. A method according to claim 1, wherein the communication network is a television IP network.

7. A method according to claim 1, further comprising:
encoding at least a portion of the visual source material prior to combining.

8. A method according to claim 1, further comprising:
transmitting the encoded multiplexed stream through the communication network to the television associated with the request.

9. A method according to claim 1 wherein the multiplexed stream is an MPEG stream.

10. A method according to claim 7, wherein encoding at least a portion of the visual source material includes compressing data of the visual source material.

11. A method according to claim 10, wherein at least a portion of data of the visual source material is compressed using MPEG compression.

12. A method according to claim 1, wherein data of the encoded audio content is MPEG encoded.

13. A method according to claim 1, wherein data of the encoded audio content is AC3 encoded.

14. A method according to claim 1, wherein at least a portion of the data of the visual source material is MPEG encoded prior to combining.

15. A system for providing encoded audio content to a decoder associated with a television, the audio content having an address associated with a link, the link being presented in visual source material, the system comprising:
a receiver for receiving a request for transmission of the encoded audio content associated with the link in the visual source material and providing the request to a retriever;
a retriever retrieving the encoded audio content associated with the link;
a video encoder for encoding at least a portion of the visual source material into a format that the decoder can decode;
a switcher having associated switching logic determining if the encoded audio content is in a form that is decodable by the decoder;
stream logic for creating a multiplexed data stream based upon the video source material and the encoded audio content that can be decoded by the decoder;
a transmitter for transmitting via a communication network the multiplexed data stream to the communication device.

16. A system according to claim 15 wherein the visual source material is a web page.

17. A system according to claim 15, wherein the decoder decodes the audio content for audible playback of the audio content.

18. A system according to claim 15 wherein the switcher directs encoded audio content not in a format that is decodable by the decoder associated with the television to a renderer.

19. A system according to claim 15, further comprising:
a renderer receiving encoded audio data not in a format that is decodable by the decoder and decoding the encoded audio data.

20. A system according to claim 19 further comprising:
an audio encoder for receiving the decoded audio data from the renderer and re-encoding the audio data into a format that is decodable by the decoder associated with the television.

21. The system according to claim 15, wherein the encoder encodes at least a portion of the visual source material in a MPEG format.

22. The system according to claim 15 wherein the encoded audio content is a MPEG encoded data.

23. The system according to claim 15, wherein the communication device associated with the television is a set-top box.
